(19) United States
(12) Patent Application Publication
(10) Pub. No.: US 2009/0053921 A1
(43) Pub. Date: Feb. 26, 2009

(54) Device for transmitting signals and current between end points

(76) Inventors: Frank Schroer Diol.Ing, Weiden (DE); Andreas Pedimonte Dipl.Ing, Weiden (DE)

Correspondence Address: SOFER & HAROUN LLP., 317 MADISON AVENUE, SUITE 910, NEW YORK, NY, 10017, US

(21) Appl. No.: 12/218,233

(22) Filed: Jul. 11, 2008

(30) Foreign Application Priority Data
Aug. 24, 2007 (EP) 07291043.3

(51) Int. Cl. H01R 3/00

(52) U.S. Cl. 439/164

(57) ABSTRACT

A device is provided for transmitting signals and current between end points which can be moved relative to one another and between which at least one flat ribbon cable that extends in turns (11, 12) is arranged. The turns (11, 12) are joined together by an inversion point (13) and divided into an inner and an outer winding region. The flat ribbon cable is accommodated in an essentially circular cassette (K) and comprises at least two electrical conductors embedded parallel to and at a distance from one another in a covering of insulating material. The cassette (K) comprises a rotor, which is rotatable about its axis and carries at least one of the end points, and a stationary stator, which likewise carries at least one of the end points, which rotor and stator enclose between them an annular winding space for receiving the flat ribbon cable. The flat ribbon cable includes means by which its elastic flexural strength, and consequently its spreading force, is increased in the region of the inversion point (13).

### RELATED APPLICATION

This application claims the benefit of priority from European Patent Application No. 07291043.3, filed on Aug. 24, 2008, the entirety of which is incorporated by reference.

### FIELD OF THE INVENTION

The invention relates to a device for transmitting signals and current between end points which can be moved relative to one another and between which at least one flat ribbon cable that extends in turns joined together by an inversion point and divided into an inner and on outer winding region is arranged, which cable is accommodated in an essentially circular cassette and comprises at least two electrical conductors embedded parallel to and at a distance from one another in a covering of insulating material, in which device the cassette comprises a rotor, which is rotatable about its axis and carries at least one of the end points, and a stationary stator, which likewise carries at least one of the end points, which rotor and stator enclose between them an annular winding space for receiving the flat ribbon cable (EP 0 735 632 B1).

### BACKGROUND

Such a device is required for example for supplying current and/or signals to movable parts of a motor vehicle. For this purpose, it may be fitted for example in the steering wheel of a motor vehicle but also elsewhere, such as for example in a steering mechanism. The main task of this device is the transmission of current and/or signals between stationary and movable parts without the use of sliding contacts.

In the case of the device according to the initially mentioned EP 0 735 632 B1, the wound flat ribbon cable is divided into an inner winding region and an outer winding region, in which the turns have different winding directions. The two winding regions of the flat ribbon cable, here in the form of a flat conductor stripline, are joined together by an approximately U-shaped inversion point. Between the two winding regions there lies an annular guiding body, which allows the inversion point to pass through and is movable in the circumferential direction of the cassette. It is moved by the wound flat conductor stripline or its inversion point when the rotor of the cassette is turned. The guiding body serves on the one hand for guiding the flat ribbon cable during the winding up and unwinding of the winding regions and on the other hand as a spacer between the two winding regions, in order that their turns do not coincide.

The known device according to EP 0 556 779 B1 works without such a guiding body for the winding regions of the flat ribbon cable. Instead, a number of flat ribbon cables, each of which has two winding regions connected by a U-shaped inversion point, are arranged in the cassette of this device. In this case, each flat ribbon cable lies with a relatively great length on the one hand against the rotor and on the other hand against the stator of the cassette. The flat ribbon cables are offset in the circumferential direction of the cassette and, if present in sufficient number, are supported against one another in such a way that their turns cannot coincide even without additional supporting bodies.

In the case of the two known devices, and similarly in the case of all other devices of this type with the flat ribbon cables divided into two winding regions, measures are required to stabilize the turns of the flat ribbon cables in their two winding regions in such a way that they do not coincide.

### OBJECTS AND SUMMARY

The invention is based on the object of designing the initially described device in such a way that, irrespective of the number of flat ribbon cables contained in the cassette, it manages without a separate supporting element.

This object is achieved according to the invention by the flat ribbon cable including means by which its elastic flexural strength, and consequently its spreading force, is increased in the region of the inversion point.

In the case of this device, in the cassette there is fitted at least one flat ribbon cable, which furthermore on the one hand has good bending characteristics and on the other hand is stabilized such that, at the inversion point, not only does it retain its bent shape of its own accord, without a separate supporting element, but also spreads or presses out the turns of the two winding regions extending from the inversion point, in the direction of the rotor on the one hand and of the stator on the other hand. The flat ribbon cable is therefore suitable in particular for cassettes with few flat ribbon cables, that is to say even just one flat ribbon cable, which (is) are divided into two winding regions connected by an inversion point. In spite of good bending characteristics, not only does it remain stably bent at the inversion point but also the turns of its winding regions lie adequately firmly against the stator on the one hand and against the rotor on the other hand without separate supporting elements. The described stabilization of the flat ribbon cable(s) and the elimination of separate supporting elements produce the further advantage that the flat ribbon cable can be bent about smaller radii at the inversion point. As a result, the winding space in the cassette can be reduced in its radial dimensions, so that the cassette as a whole can also be given smaller dimensions.

A measure for increasing the bending resistance of the flat ribbon cable is, for example, the use of a special alloy with resilient characteristics for at least some of the conductors. It is also possible to use along with the conductors additional resilient elements, which run parallel to and at a distance from the conductors.

### BRIEF DESCRIPTION OF THE DRAWINGS

Exemplary embodiments of the subject matter of the invention are represented in the drawings, in which:

FIG. 1 shows a view of a cassette for the device according to the invention in a schematic representation.

FIG. 2 shows an embodiment of a cassette that can be used in the device and has additional features in comparison with FIG. 1.

FIGS. 3 and 4 show differently constructed cables that can be used in a cassette in a schematic representation.

### DETAILED DESCRIPTION

The construction and arrangement of a device with a cassette that is to be fitted for example in the steering wheel of a vehicle are known in principle and are described for example in the documents initially mentioned. Therefore, corresponding details are not described any further here. Instead of the word “device”, the word “cassette” is used hereafter for the sake of simplicity.

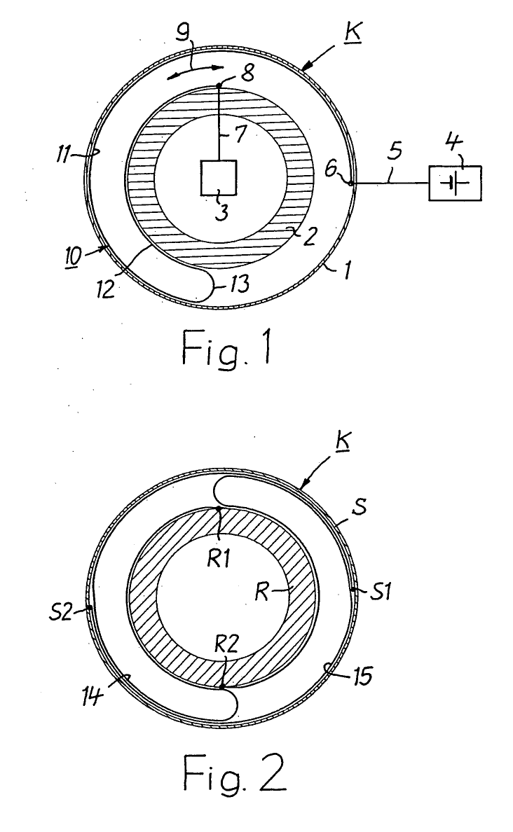

In FIG. 1, two concentrically arranged walls 1 and 2 of a cassette K, for example of a circular form, are represented schematically. The wall 1 belongs for example to the stator of the cassette K, while the wall 2 belongs to its rotor. The cassette K is intended for fitting into the steering wheel of a motor vehicle. To supply current to an electronic unit 3, the signal of which can be used to trigger an airbag, the cassette K is connected to a voltage source 4 of the motor vehicle. The voltage source 4 is connected by means of an electrical cable 5 to an end point 6 of the cassette K formed as a fixed point. The electronic unit 3 is connected by means of an electrical cable 7 to an end point 8 of the cassette K, which is movable in the direction of the double-headed arrow 9. In principle, the end point 8 could also be stationary and the end point 6 movable. Provided between the two end points 6 and 8 is a flat ribbon cable 10 with at least two electrical conductors. In a preferred embodiment, the flat ribbon cable 10 is formed as a flat conductor stripline with flat or rectangular conductors. Such a line is relatively thin as a whole and takes up little space, even if it extends in a number of turns lying next to one another.

According to FIG. 1, the flat ribbon cable 10 is arranged in the cassette K in turns that are divided into an outer winding region 11 and an inner winding region 12. In a middle position or in the fitting position of the cassette K that can be seen from FIG. 1, they respectively comprise at least one turn. In the two winding regions 11 and 12, the turns of the flat ribbon cable 10 have opposed winding directions. They lie on the one hand against the stator (wall 1) and on the other hand against the rotor (wall 2) of the cassette K. The winding regions 11 and 12 are joined together by an approximately U-shaped inversion point 13 of the flat ribbon cable 10.

When the steering wheel of a vehicle in which the cassette K is fitted is turned, its rotor is turned with it in the direction of the double-headed arrow 9. The rotor takes the connected flat ribbon cable 10 with it beyond the end point 8, so that its inversion point 13 travels back and forth in the circumferential direction of the cassette K.

The flat ribbon cable 10 has increased elastic flexural strength, so that its spreading force in the region of the inversion point 13 is increased to the extent that its turns in the winding regions 11 and 12 are pressed outward by the flat ribbon cable 10 of its own accord, in the direction of the stator (wall 1) on the one hand and the rotor (wall 2) on the other hand. This advantageous construction of the flat ribbon cable 10 also allows smaller bending radii at the inversion point 13, while retaining the increased spreading force of the flat ribbon cable 10. As a result, the distance between the stator and the rotor can be reduced, so that the outer dimensions of the cassette K can also be reduced.

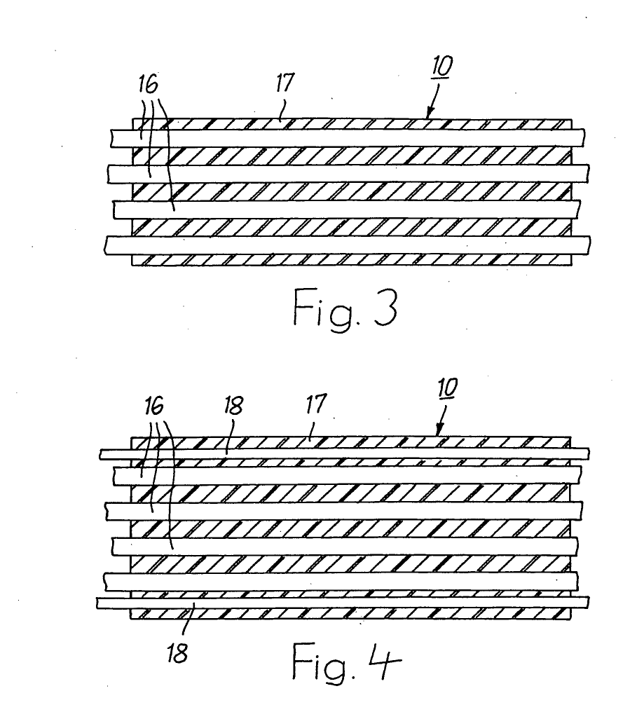

The increased elastic flexibility of the flat ribbon cable 10 can be achieved by the use of suitable materials for the conductors 16 (FIGS. 3 and 4) of the flat ribbon cable 10. For this purpose, the conductors 16 may be produced from a resilient material with good electrical conducting properties, with preference from a resilient copper alloy. In the case of flat ribbon cables with a relatively great number of conductors 16, it may be adequate if only some of them have the resilient properties and properties specified hereafter. The remaining conductors may then be constructed in the conventional way.

The conductors 16 of the flat ribbon cable 10 with the mentioned special properties may also consist of a copper-beryllium alloy or of an iron-cobalt-nickel alloy. Also suitable is a copper alloy known by the designation C155, with small amounts of tin, magnesium, silver and phosphorus as additives. The conductors 16 may also consist of a copper-nickel alloy referred to as new silver. Finally, conductors 16 consisting of brass or bronze may also be used.

The facts described in relation to FIG. 1 also apply to a device as shown in FIG. 2, which shows a cassette K with two flat ribbon cables 14 and 15, the end points S1 and S2 as well as R1 and R2 of which are arranged offset by 180° with respect to one another on the stator on the one hand and on the rotor on the other hand. In a practical embodiment, the end points of the rotor on the one hand and of the stator on the other hand are respectively grouped together at one point, for example in part of a plug-in connector, in order that continuing lines can be connected, for example by means of a plug.

A cassette K may also be fitted with more than two flat ribbon cables, which are expediently offset with respect to one another in the circumferential direction of the cassette K at the same distance from one another.

A flat ribbon cable 10, or all the flat ribbon cables fitted in a cassette K, is or are constructed for example in a way corresponding to FIGS. 3 and 4:

The flat ribbon cable 10 has, for example, four electrical conductors 16 extending parallel to and at a distance from one another, which are embedded immovably in a common insulation 17. There should be at least two conductors 16 in the flat ribbon cable 10. However, there may also be more than four conductors 16. The conductors 16 may also have different dimensions. They advantageously consist of the materials specified above.

According to FIG. 4, in addition to the conductors 16, it is also possible for example to embed in the insulation 17 two resilient elements 18, which extend parallel to and at a distance from the conductors 16. There should be at least one resilient element 18, which is arranged between the conductors 16. If at least one resilient element 18 is used, the conductors 16 could be constructed in the conventional way.

1. Device for transmitting signals and current between end points which can be moved relative to one another and, said device comprising:
disposed between said end points, at least one flat ribbon cable that extends in turns joined together by an inversion point and divided into an inner and an outer winding region;
an essentially circular cassette for accommodating said cable, said cassette having at least two electrical conductors embedded parallel to and at a distance from one another in a covering of insulating material,
a rotor, which is rotatable about its axis and carries at least one of the end points, and
a stationary stator, which likewise carries at least one of the end points, said rotor and stator enclose between them an annular winding space for receiving the flat ribbon cable,
wherein the flat ribbon cable includes means by which its elastic flexural strength, and consequently its spreading force, is increased in the region of the inversion point.

2. Device according to claim 1, wherein the conductors of the flat ribbon cable include resilient material with good electrical conducting properties.

3. Device according to claim 1, wherein the conductors of the flat ribbon cable include a resilient copper alloy.

4. Device according to claim 1, wherein the conductors of the flat ribbon cable include a copper-beryllium alloy.

5. Device according to claim 1, wherein the conductors of the flat ribbon cable include an iron-cobalt-nickel alloy.

6. Device according to claim 1, wherein the conductors of the flat ribbon cable include a copper alloy with small amounts of tin, magnesium, silver and phosphorus as additives.

7. Device according to claim 1, wherein the conductors of the flat ribbon cable include new silver.

8. Device according to claim 1, wherein the conductors of the flat ribbon cable include bronze.

9. Device according to claim 1, wherein the conductors of the flat ribbon cable include brass.

10. Device according to claim 1, wherein, along with the conductors, at least one resilient element, which runs parallel to and at a distance from them, is provided in the flat ribbon cable.
